(19) United States
(12) Patent Application Publication
(10) Pub. No.: US 2019/0035382 A1
(43) Pub. Date: Jan. 31, 2019

(54) ADAPTIVE POST FILTERING

(71) Applicant: HARMAN BECKER AUTOMOTIVE SYSTEMS GMBH, Karlsbad-Ittersbach (DE)

(72) Inventor: Markus CHRISTOPH, Straubing (DE)

(21) Appl. No.: 16/046,926

(22) Filed: Jul. 26, 2018

(30) Foreign Application Priority Data
Jul. 31, 2017 (EP) 17 183 948.3

(51) Int. Cl. G10K 11/178

(52) U.S. Cl. CPC G10K 11/17854

(57) ABSTRACT

One embodiment is directed towards an adaptive blocking system that includes a blocking mask block configured to generate from at least one of a desired signal and an undesired signal input into the blocking mask block an output signal that per se or in combination with the desired signal or undesired signal provides a mask signal. The undesired signal includes components occurring also in the desired signal or the desired signal includes components occurring also in the undesired signal. The output signal is the undesired signal with reduced or no components occurring also in the desired signal or the desired signal with reduced or no components occurring also in the undesired signal.

### CROSS-REFERENCE TO RELATED APPLICATIONS

This application claims priority to the co-pending European patent application titled, “ADAPTIVE POST FILTERING,” filed on Jul. 31, 2017 and having Serial No. EP 17 183 948.3. The subject matter of this related application is hereby incorporated herein by reference

### BACKGROUND

### Technical Field

The disclosure relates to an adaptive post filtering system and method and computer-readable media that includes instructions for performing the method (generally referred to herein as “system”).

### Description of the Related Art

Systems for far field sound capturing, also referred to as far field microphones or far field microphone systems, are adapted to record sounds from a desired sound source that is positioned at a greater distance (e.g., several meters) from the far field microphone. The greater the distance between sound source and the far field microphone, the lower the desired sound to noise ratio is. The term “noise” in the instant case includes sound that carries no information, ideas or emotions, e.g., no speech or music. If the noise is undesired, it is also referred to as noise. When speech or music is introduced into a noise-filled environment such as a vehicle, home or office interior, the noise present in the interior can have an undesired interfering effect on a desired speech communication or music presentation. Noise reduction is commonly the attenuation of undesired signals but may also include the amplification of desired signals. Desired signals may be speech signals, whereas undesired signals can be any sounds in the environment which interfere with the desired signals. There have been three main approaches used in connection with noise reduction: Directional beamforming, spectral subtraction, and pitch-based speech enhancement. Systems designed to receive spatially propagating signals often encounter the presence of interference signals. If the desired signal and interferers occupy the same temporal frequency band, then temporal filtering cannot be used to separate the desired signal from the interferer. It is desired to improve noise reduction systems and methods.

### SUMMARY

An adaptive blocking system includes a blocking mask block configured to generate from at least one of a desired signal and an undesired signal input into the blocking mask block an output signal that per se or in combination with the desired signal or undesired signal provides a mask signal, wherein the undesired signal includes components occurring also in the desired signal or the desired signal includes components occurring also in the undesired signal, and the output signal is the undesired signal with reduced or no components occurring also in the desired signal, or the desired signal with reduced or no components occurring also in the undesired signal.

An adaptive blocking method includes: generating from at least one of a desired signal and an undesired signal input into a blocking mask an output signal that per se or in combination with the desired signal or undesired signal provides a mask signal, wherein the undesired signal includes components occurring also in the desired signal or the desired signal includes components occurring also in the undesired signal, and the output signal is the undesired signal with reduced or no components occurring also in the desired signal, or the desired signal with reduced or no components occurring also in the undesired signal.

Other systems, methods, features and advantages will be, or will become, apparent to one with skill in the art upon examination of the following detailed description and appended figures. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. In the Figures, like referenced numerals designate corresponding parts throughout the different views.

FIG. 1 is a schematic diagram illustrating an exemplary far field microphone system.

FIG. 2 is a schematic diagram illustrating an exemplary acoustic echo canceler applicable in the far field microphone system shown in FIG. 1.

FIG. 3 is a schematic diagram illustrating an exemplary filter and sum beamformer.

FIG. 4 is a schematic diagram illustrating an exemplary beam steering block.

FIG. 5 is a schematic diagram illustrating a structure of an exemplary adaptive interference canceler without an adaptive blocking filter.

FIG. 6 is a schematic diagram illustrating a structure of another exemplary adaptive interference canceler without an adaptive blocking filter.

FIG. 7 is a schematic diagram illustrating a structure of an exemplary adaptive blocking filter (system).

FIG. 8 is a schematic diagram illustrating a structure of another exemplary adaptive blocking filter (system).

FIG. 9 is a schematic diagram illustrating a structure of an exemplary speech blocking mask block.

FIG. 10 is a schematic diagram illustrating a structure of an exemplary adaptive blocking filter applied in an adaptive interference canceler.

FIG. 11 is a schematic diagram illustrating another structure of an exemplary adaptive blocking filter applied in an adaptive interference canceler.

FIG. 12 is a schematic diagram illustrating another structure of a structure of an exemplary adaptive blocking filter applied in an adaptive interference canceler.

The Figures describe concepts in the context of one or more structural components. The various components shown in the figures can be implemented in any manner including, for example, software or firmware program code executed on appropriate hardware, hardware and any combination thereof. In some examples, the various components may reflect the use of corresponding components in an actual implementation. Certain components may be broken down into plural sub-components and certain components can be implemented in an order that differs from that which is illustrated herein, including a parallel manner.

### DETAILED DESCRIPTION

It has been found that the desired signals and interfering signals often originate from different spatial locations. Therefore, beamforming techniques may be used to improve signal-to-noise ratio in audio applications. Common beamforming techniques include delay and sum techniques, adaptive finite impulse response (FIR) filtering techniques using algorithms such as the Griffiths-Jim algorithm, and techniques based on the modeling of the human binaural hearing system.

Beamformers can be classified as either data independent or statistically optimum, depending on how the weights are chosen. The weights in a data independent beamformer do not depend on the array data and are chosen to present a specified response for all signal/interference scenarios. Statistically optimum beamformers select the weights to optimize the beamformer response based on statistics of the data. The data statistics are often unknown and may change with time, so adaptive algorithms are used to obtain weights that converge to the statistically optimum solution. Computational considerations dictate the use of partially adaptive beamformers with arrays composed of large numbers of sensors. Many different approaches have been proposed for implementing optimum beamformers. In general, the statistically optimum beamformer places nulls in the directions of interfering sources in an attempt to maximize the signal to noise ratio at the beamformer output.

In many applications the desired signal may be of unknown strength and may not always be present. In such situations, the correct estimation of signal and noise covariance matrices in the maximum signal-to-noise ratio (SNR) is not possible. Lack of knowledge about the desired signal may impede utilization of the reference signal approach. These limitations may be overcome through the application of linear constraints to the weight vector. Use of linear constraints is a very general approach that permits extensive control over the adapted response of the beamformer. A universal linear constraint design approach does not exist and in many applications a combination of different types of constraint techniques may be effective. However, attempting to find either a single best way or a combination of different ways to design the linear constraint may limit the use of techniques that rely on linear constraint design for beamforming applications.

Generalized sidelobe canceller (GSC) technology presents an alternative formulation for addressing the drawbacks associated with the linear constraint design technique for beamforming applications. Essentially, GSC is a mechanism for changing a constrained minimization problem into unconstrained form. GSC leaves the desired signals from a certain direction undistorted, while, at the same time, undesired signals radiating from other directions are suppressed. However, GSC uses a two path structure; a desired signal path to realize a fix beamformer pointing to the direction of the desired signal, and an undesired signal path that adaptively generates an ideally pure noise estimate, which is subtracted from the output signal of the fix beamformer, thus increasing its signal-to-noise ratio (SNR) by suppressing noise.

The undesired signal path, i.e. the estimation of the noise, may be realized in a two-part approach. A first block of the undesired signal path is configured to remove or block remaining components of the desired signal from the input signals of this block, which is, e.g., an adaptive blocking filter in case of a single input, or an adaptive blocking matrix if more than one input signal is used. A second block of the undesired signal path may further comprise an adaptive (multi-channel) interference canceller (AIC) in order to generate a single-channel, estimated noise signal, which is then subtracted from the output signal of the desired signal path, e.g., an optionally time delayed output signal of the fix beamformer. Thus, the noise contained in the optionally time delayed output signal of the fix beamformer can be suppressed, leading to a better SNR, as the desired signal component ideally would not be affected by this processing. This holds true if and only if all desired signal components within the noise estimation could successfully be blocked, which is rarely the case in practice, and thus represents one of the major drawbacks related to current adaptive beamforming algorithms.

Acoustic echo cancellation can be achieved, e.g., by subtracting an estimated echo signal from the total sound signal. To provide an estimate of the actual echo signal, algorithms have been developed that operate in the time domain and that may employ adaptive digital filters that process time-discrete signals. Such adaptive digital filters operate in such a way that network parameters defining the transmission characteristics of the filter are optimized with reference to a preset quality function. Such a quality function is realized, for example, by minimizing the average square errors of the output signal of the adaptive network with reference to a reference signal.

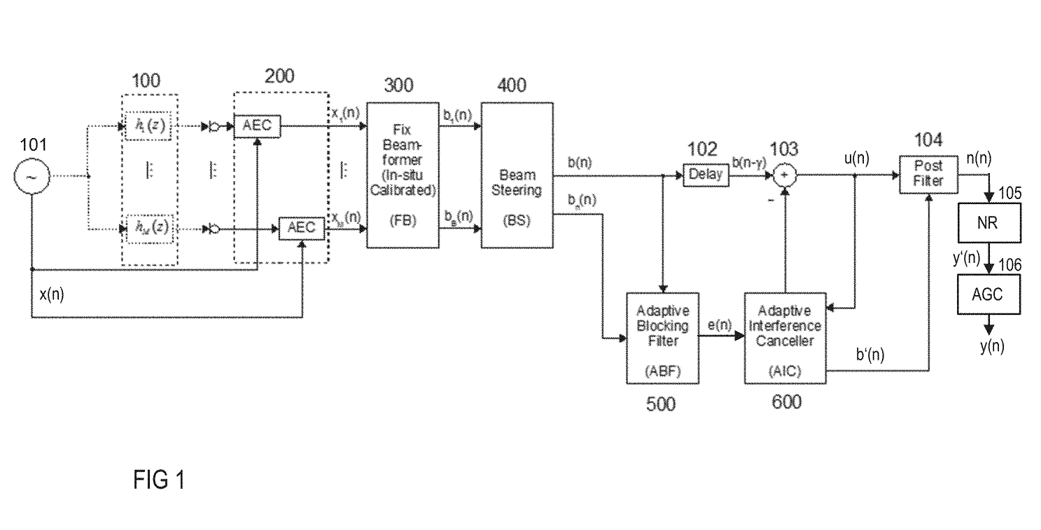

Referring now to FIG. 1, in an exemplary far field sound capturing system, sound, which corresponds to a source signal x(n) with n being a (discrete) time index, from a desired sound source 101, is radiated via one or a plurality of loudspeakers (not shown), travels through a room (not shown), where it is filtered with the corresponding room impulse responses (RIRs) 100 represented by transfer functions h₁(z) . . . h_{M}(z), wherein z being a frequency index, and may eventually be corrupted by noise, before the resulting sound signals are picked up by M (M is an integer, e.g., 2, 3 or more) microphones which provide M microphone signals. The exemplary far field sound capturing system shown in FIG. 1 includes an acoustic echo cancellation (AEC) block 200 providing M echo canceled signals x₁(n) . . . x_{M}(n), a subsequent fix beamformer (FB) block 300 providing B (B is an integer, e.g., 1, 2 or more) beamformed signals b₁(n) . . . b_{B}(n), a subsequent beam steering block 400 which provides a desired-source beam signal b(n), also referred to herein as positive-beam output signal b(n), and, optionally, an undesired-source beamsignal bₙ(n), also referred to herein as negative-beam output signal bₙ(n). The blocks 100, 200, 300 and 400 are operatively coupled with each other to form at least one signal chain (signal path) between block 100 and block 400. An optional undesired signal (negative-beam) operatively coupled with the output of beam steering block 400 and supplied with the undesired-source beam signal bₙ(n) includes an optional adaptive blocking filter (ABF) block 500 and a subsequent adaptive interference canceller (AIC) block 600 operatively coupled with the ABF block 500. The ABF block 500 may provide an error signal e(n). Alternatively, the original M microphone signals or the M output signals of the AEC block 200 or the B output signals of the FB block 300 may be used as input signals to the ABF block 500, optionally overlaid with the undesired-source beam signal bₙ(n), to establish an optional multichannel adaptive blocking matrix (ABM) block as well as an optional multichannel AIC block.

A desired signal (positive-beam) path also operatively coupled with the beam steering block 400 and supplied with the desired-source beam signal b(n) includes a series-connection of an optional delay block 102, a subtractor block 103 and an (adaptive) post filter block 104. The adaptive post filter 104 receives an output signal u(n) from the subtractor block 103 and a control signal b′(n) from AIC block 600. An optional speech pause detector (not shown) may be connected to and downstream of the adaptive post filter block 104 as well as a noise reduction (NR) block 105 and an optional automatic gain control (AGC) block 106, each of which, if present, may be connected upstream of the speech pause detector. It is noted that the AEC block 200, instead of being connected upstream of the FB block 300 as shown, may be connected downstream thereof, which may be beneficial if B<M, i.e., fewer beamformer blocks are available than microphones. Further, the AEC block 200 may be split into a multiplicity of sub-blocks (not shown), e.g., short-length sub-blocks for each microphone signal and a long-length sub-block (not shown) downstream of the BS block 400 for the desired-source beam signal and optionally another long-length sub-block (not shown) for the undesired-source beam signal. Further, the system is applicable not only in situations with only one source as shown but can be adapted for use in connection with a multiplicity of sources. For example, if stereo sources that provide two uncorrelated signals are employed, the AEC blocks may be substituted by stereo acoustic echo canceller (SAEC) blocks (not shown).

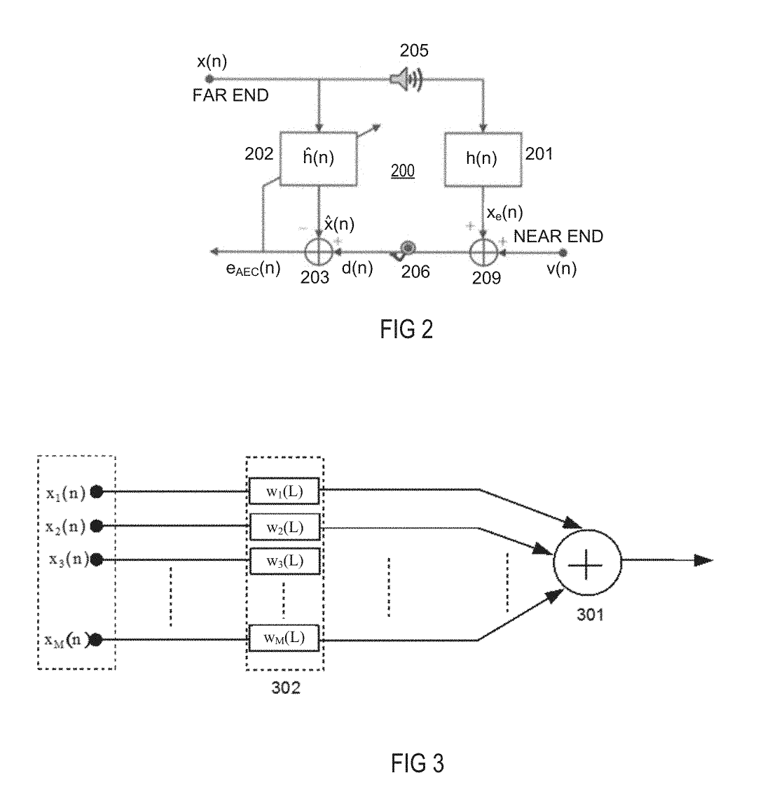

As can be seen from FIG. 1, N(=1) source signals x(n), filtered by the N×M RIRs, and possibly interfered with by noise, serve as an input to the AEC blocks 200. FIG. 2 depicts an exemplary realization of a single microphone (206), single loudspeaker (205) AEC block 200. As would be understood and appreciated by those skilled in the art, such a configuration can be extended to include more than one microphone 206 and/or more than one loudspeaker 205. A far end signal, represented by the source signal x(n), travels via loudspeaker 205 through an echo path 201 having the transfer function (vector) h(n)=(h₁, . . . , h_{M}) to provide an echo signal xₑ(n). This signal is added at a summing node 209 to a near-end signal v(n) which may contain both background noise and near-end speech, resulting in an electrical microphone (output) signal d(n). An estimated echo signal \hat{x}ₑ(n) provided by an adaptive filter block 202 is subtracted from the microphone signal d(n) at a subtracting node 203 to provide an error signal e_{AEC}(n). The adaptive filter 202 is configured to minimize the error signal e_{AEC}(n).

FIR filter 202 with transfer function ĥ(n) of order L−1, wherein L is a length of the FIR filter, is used to model the echo path. The transfer function ĥ(n) is given as

[ĥ(0,n), . . . ĥ(L−1,n),]^{T}

The desired microphone signal d(n) at block 203 for the adaptive filter is given as

d(n)=x^{T}(n)h(n)+v(n),

wherein x(n)=[x(n) x(n−1) . . . x(n−L+1)]^{T} is a real-valued vector containing L (L is an integer) most recent time samples of the input signal, x(n), and v(n), i.e., the near-end signal with may include noise.

Using the previous notations, the feedback/echo error signal is given as

e_{AEC}(n)=d(n)−x^{T}(n−1)ĥ(n)=x^{T}(n)[h(n)−ĥ(n)]+v(n),

wherein vectors h(n) and ĥ(n) contain the filter coefficients representing the acoustical echo path and its estimation by the adaptive filter coefficients at time n. The cancellation filters h(n) are estimated using, e.g., a Least Mean Square (LMS) algorithm or any state-of the art recursive algorithm. The LMS update using a step size of μ(n) of the LMS-type algorithm can be expressed as

ĥ(n)=ĥ(n−1)+μ(n)x(n)e(n).

A simple yet effective beamforming technique is the delay-and-sum (DS) technique. Referring again to FIG. 1, the outputs of AEC blocks 200 serve as inputs xᵢ(n), with i=1, . . . ,M, to the fix beamformer block 300. A general structure of a fix filter and sum (FS) beamformer block 300 including filter blocks 302 with at least one of transfer functions wᵢ(L), i=1, . . . ,M, and wᵢ(L)=[wᵢ(0), . . . , wᵢ(L−1)], L being the length of filters within the FB, is shown in FIG. 3. If the filter blocks 302 implement desired (factual) delays, the output beamformer signals bⱼ(n) with j=1, . . . ,B, are given as

$${b}_{j} ( n ) = \frac{1}{M} {\sum }_{i = 1}^{M} {x}_{i} ( n - {τ}_{i , j} ) ,$$

wherein M is the number of microphones and for each (fix) beamformer output signal bⱼ(n) with j=1, . . . ,B, each microphone has a delay τ_{i,j} relative to each other. The FS beamformer may include a summer 301 which receives the input signals xᵢ(n) via filter blocks 302 having the transfer functions wᵢ(L).

Referring again to FIG. 1, the beamformer signals bⱼ(n) output by the fix FS beamformer block 300 serve as an input to the beam steering (BS) block 400. Each signal from the fix beamformer block 300 is taken from a different room direction and may have a different SNR level. The input signals bⱼ(n) of the beam steering block 400 may contain low frequency components such as low frequency rumble, direct current (DC) offsets and unwanted vocal plosives in case of speech signals. These artifacts may impinge on the input signal bⱼ(n) of the BS block 400 and should be removed.

Alternatively, the beam pointing to the undesired signal (e.g., noise) source, i.e. the undesired-signal beam, can be approximated based on the beam pointing to the desired sound source, i.e. the desired-signal beam, by letting it point to the opposite direction of the beam pointing to the desired sound source, which would result in a system using less resources and also in beams having exactly the same time variations. Further, this allows both beams to never point in the same direction.

As a further alternative, instead of just using the beam pointing to the desired-source direction (positive beam) a summation of this with its neighboring beams may be used as positive-beam output signal, since all of them contain a high level of desired signals, which are correlated to each other and would as such be amplified by the summation. On the other hand, noise parts contained in the three neighboring beams are uncorrelated to each other and will as such be suppressed by the summation. As a result, the final output signal of the three neighboring beams will improve SNR.

The beam pointing to the undesired-source direction (negative beam) can alternatively be generated by using all output signals of the FB block except the one representing the positive beam. This leads to an effective directional response having a spatial zero in the direction of the desired signal source. Otherwise, an omnidirectional character is applicable, which may be beneficial since noise usually enters the microphone array also in an omnidirectional way, and only rarely in a directional form.

Further, the optionally delayed, desired signal from the BS block may form the basis for the output signal and as such is input into the optional adaptive post filter. The adaptive post filter, which is controlled by the AIC block and which delivers a filtered output signal, can optionally be input into a subsequent single channel noise reduction block (e.g., NR block 105 in FIG. 1), which may implement the known spectral subtraction method, and an optional (e.g., final) automatic gain control block (e.g., AGC block 106 in FIG. 1).

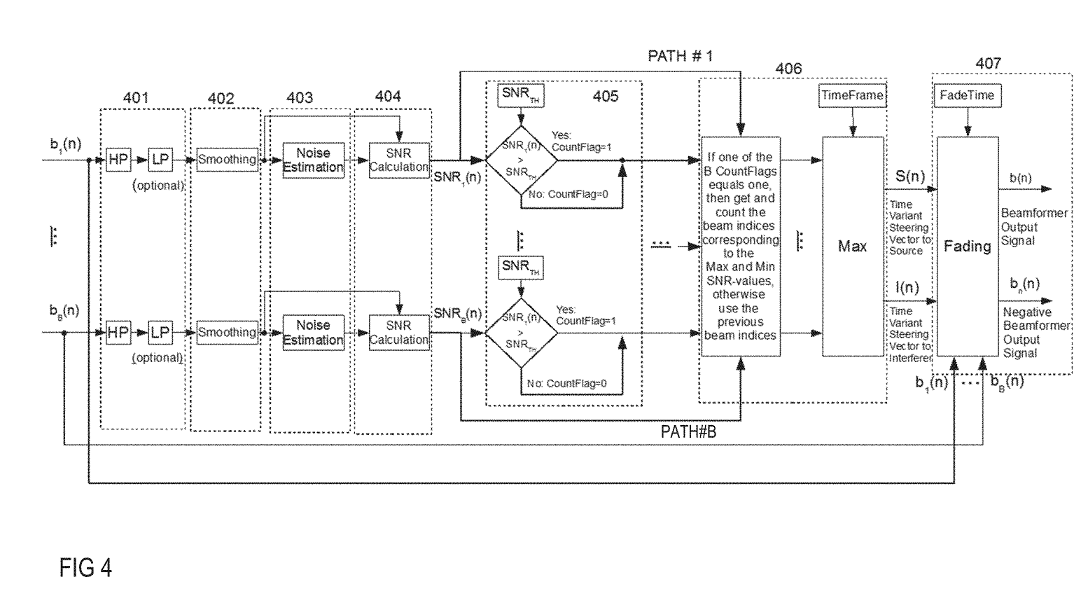

Referring to FIG. 4, in beam steering block 400 its input signals bⱼ(n) are filtered using a high pass (HP) filter and an optional low pass (LP) filter block 401 in order to block signal components that are either affected by noise or do not contain useful signal components, e.g., certain speech signal components. The output from filter block 401 may have amplitude variations due to noise that may introduce rapid, random changes in amplitude from point to point within the signal bⱼ(n). In this situation, it may be useful to reduce noise, e.g., in a smoothing block 402 shown in FIG. 4.

The filtered signal from filter block 401 is smoothed by applying, e.g., a low pass infinite impulse response (IIR) filter or an moving average (MA) finite impulse response (FIR) filter (both not shown) in smoothing block 402, thereby reducing the high frequency components and passing the low-frequency components with little change. The smoothing block 402 outputs a smoothed signal that may still contain some level of noise and thus, may cause noticeable sharp discontinuities as described above. The level of voice signals typically differs distinctly from the variation of the level of background noise, particularly due to the fact that the dynamic range of a level change of voice signals is greater and occurs in much shorter intervals than a level change of background noise. A linear smoothing filter in a noise estimation block 403 would therefore smear out the sharp variation in the desired signal, e.g., music or voice signal, as well as filter out the noise. Such smearing of a music or voice signal is unacceptable in many applications, therefore a non-linear smoothing filter (not shown) may be applied to the smoothed signal in noise estimation block 403 to overcome the artifacts mentioned above. The data points in output signal bⱼ(n) of smoothing block 402 are modified in a way that individual points that are higher than the immediately adjacent points (presumably because of noise) are reduced, and points that are lower than the adjacent points are increased. This leads to a smoother signal (and a slower step response to signal changes).

Next, based on the smoothed signal from smoothing block 402 and the estimated background noise signal from noise estimation block 403, the variations in the SNR value are calculated. Using variations in the SNR, a noise source can be differentiated from a desired speech or music signal. For example, a low SNR value may represent a variety of noise sources such as an air-conditioner, a fan, an open window, or an electrical device such as a computer etc. The SNR may be evaluated in a time domain or in a frequency domain or in a sub-band frequency domain.

In a comparator block 405, the output SNR value from block 404 is compared to a pre-determined threshold. If the current SNR value is greater than a pre-determined threshold, a flag indicating, e.g., a desired speech signal will be set to, e.g., ‘1’. Alternatively, if the current SNR value is less than a pre-determined threshold, a flag indicating an undesired signal such as noise from an air-conditioner, fan, an open window, or an electrical device such as a computer will be set to ‘0’.

SNR values from blocks 404 and 405 are passed to a controller block 406 via paths #1 to path #B. A controller block 406 compares the indices of a plurality of SNR (both low and high) values collected over time against the status flag in comparator block 405. A histogram of the maximum and minimum values is collected for a pre-determined time period. The minimum and maximum values in a histogram are representative of at least two different output signals. At least one signal is directed towards a desired source denoted by S(n) and at least one signal is directed towards an interference source denoted by I(n).

If the indices for low and high SNR values in controller block 406 change over time, a fading process is initiated that allows a smooth transition from one to the other output signal, without generating acoustic artifacts. The outputs of the BS block 400 represent desired-signal and optionally undesired-signal beams selected over time. Here, the desired-signal beam represents the fix beamformer output b(n) having the highest SNR. The optional undesired beam represents a fix beamformer output bₙ(n) having the lowest SNR.

The outputs of BS block 400 contain a signal with a high SNR (positive beam) which can be used as a reference by the optional adaptive blocking filter (ABF) block 500 and an optional one with a low SNR (negative beam), forming a second input signal for the optional ABF block 500. The ABF filter block 500 may use least mean square (LMS) algorithm controlled filters to adaptively subtract the signal of interest, represented by the reference signal b(n) (representing the desired-source beam) from the signal bₙ(n) (representing the undesired-source beam) and provides error signal(s) [symbol] (n). Error signal(s) [symbol] (n) obtained from ABF block 500 is/are passed to the adaptive interference canceller (AIC) block 600 which adaptively removes the signal components that are correlated to the error signals from the beamformer output of the fix beamformer 300 in the desired-signal path. As already mentioned, other signals can alternatively or additionally serve as input to the ABM block. However, the adaptive beamformer block including optional ABM, AIC and APF blocks can be partly or totally omitted.

First, AIC block 600 computes an interference signal using an adaptive filter (not shown). Then, the output of this adaptive filter is subtracted from the optionally delayed (with delay 102) reference signal b(n), e.g., by a subtractor 103 to eliminate the remaining interference and noise components in the reference signal b(n). Finally, an adaptive post filter 104 may be disposed downstream of subtractor 103 for the reduction of statistical noise components (not having a distinct autocorrelation). As in the ABF block 500, the filter coefficients in the AIC block 600 may be updated using the adaptive LMS algorithm. The norm of the filter coefficients in at least one of AIC block 600, ABF block 500 and AEC blocks may be constrained to prevent them from growing excessively large.

FIG. 5 illustrates an exemplary system for eliminating noise from the desired-source beam (positive beam) signal b(n). Thereby, the noise component included in the signal b(n), which is represented by signal z(n) in FIG. 5, is provided by an adaptive system, which includes a filter control block 700 that controls by way of a filter control signal b″(n) a controllable filter 800. The signal b(n) is subtracted by way of the subtractor block 103 from the desired signal b(n), optionally after being delayed in a delay block 102 as a delayed desired signal b(n-γ), to provide an adder output signal u(n) containing, to a certain extent, reduced undesired noise. The signal bₙ(n), which represents the undesired-signal beam and ideally only contains noise and no useful signal such as speech, is used as a reference signal for the filter control block 700 which also receives as an input the adder output signal. The known normalized least mean square (NLMS) algorithm may be used to filter noise out from the desired signal b(n) provided by BS block 400. The noise component in the desired signal b(n) is estimated by the adaptive system including filter control block 700 and controllable filter 800. Controllable filter 800 filters the undesired signal bₙ(n) under control of filter control block 700 to provide an estimate of the noise contained in the desired signal b(n), which is subtracted from the (optionally) delayed desired signal b(n-γ) in subtractor block 103 to reduce further noise in the desired signal b(n). This will in turn increase the signal-to-noise (SNR) ratio of the desired signal b(n). The filter control signal b″(n) from filter control block 700 is further used to control the adaptive post filter 104. The system shown in FIG. 5 employs no optional ABF or ABM block since an additional blocking of signal components of the undesired signal, performed by the ABF or ABM block, may be omitted if it has little effect in increasing the quality of the pure noise signal in comparison to the desired signal. Thus, it may be reasonable to omit the ABF or ABM block without deteriorating the performance of the adaptive beamformer dependent on the quality of the undesired signal bₙ(n).

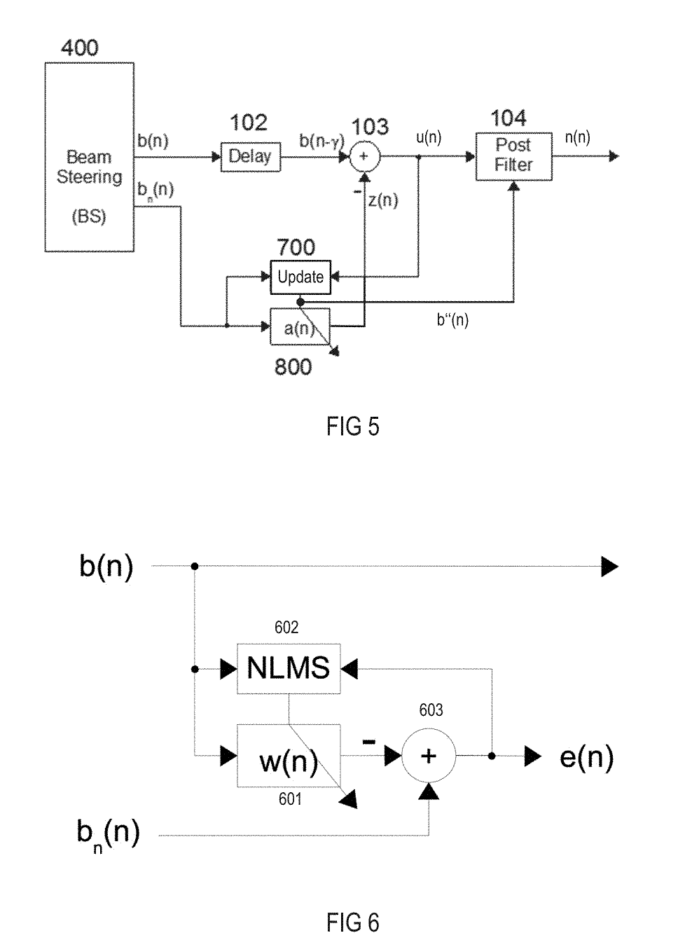

Referring to FIG. 6, an exemplary alternative AIC for eliminating noise from the desired-source beam (positive beam), i.e., from the signal representative of the positive beam b(n), includes a controllable filter 601, which has transfer function w(n), and a filter controller 602, which controls the controllable filter 601, i.e., its transfer function w(n). Both the controllable filter 601 and the filter controller 602 receive the signal representative of the positive beam b(n) and form in combination an adaptive filter. Filter controller 602 further receives an output signal of a subtractor 603, which is an estimated noise signal e(n) representative of noise contained in the desired-source beam. The subtractor 603 receives the signal representative of the negative beam bₙ(n), i.e., the undesired-source beam, and a signal output by the controllable filter 601.

In the system shown in FIG. 6, the signal representative of the positive beam b(n), which mainly contains the useful signal (speech), is used as a reference signal for the adaptive filter (exemplarily shown in a time domain version), which utilizes the NLMS algorithm for filter update, in connection with the signal representative of the negative beam bₙ(n), which mainly contains undesired signal parts (noise). The purpose of employing an ABF is that, by way of minimization of the squared estimated-noise signal e(n), the transfer function w(n) of the adaptive filter is adjusted so that it outputs a signal that allows mimicing the useful signal parts still contained in the signal representative of the negative beam bₙ(n). This means, components of the useful signal (e.g., speech) still contained in the signal representative of the negative beam bₙ(n) are estimated by way of filtering the reference signal with the transfer function w(n). The filtered reference signal is subtracted from the signal representative of the negative beam bₙ(n) to remove from the signal representative of the negative beam bₙ(n) the residual parts of the useful signal (speech). Thus, the purpose of the ABF is to block remaining speech signal parts within the signal representative of the negative beam bₙ(n) to finally get an estimate of the noise without useful (speech) signal components, i.e., estimated noise signal e(n) which can then be used as a reference for the successive AIC. By providing a reference having no speech signal components to the AIC, an undesired suppression of speech signal parts by the AIC can be reduced or avoided. As a consequence, AIC solely suppresses undesired (noise) parts, which leads to an increase in the SNR of its output signal. Unfortunately, the correlation of the speech signals within the positive and negative beam may be sometimes unsatisfactory. Consequently, since adaptive systems rely on a sufficient correlation, the removal of speech parts from the negative beam cannot be successful. In the following, an ABF is described, which is less prone to correlating signals.

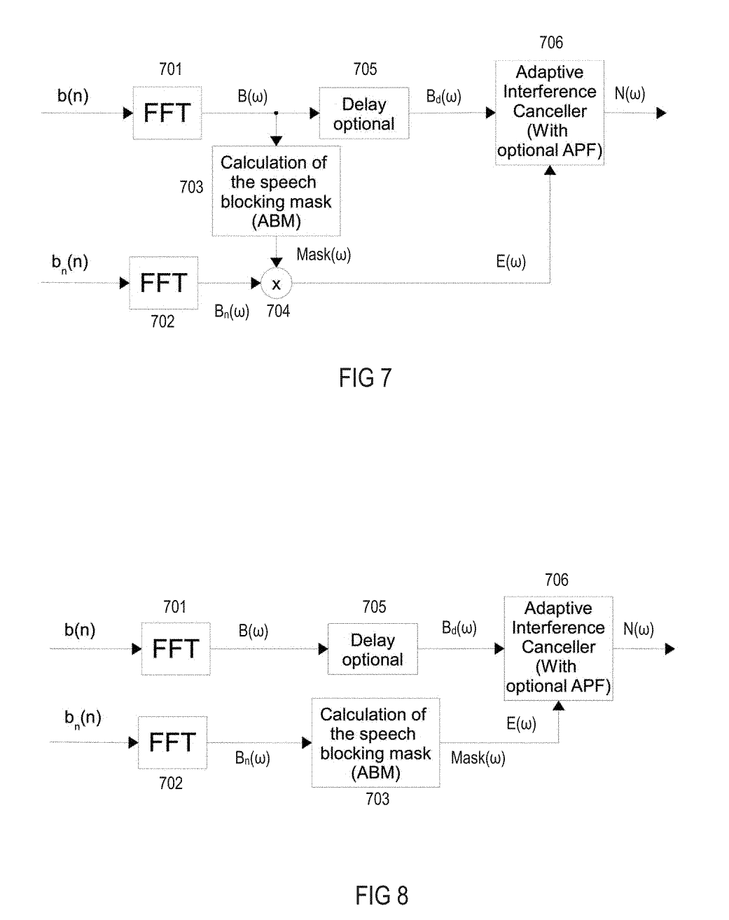

Referring to FIG. 7, an exemplary ABF includes two domain transformation blocks 701 and 702, in which the signal representative of the positive beam b(n) and the signal representative of the negative beam bₙ(n) are transformed from the time domain into the spectral domain, i.e., into a spectral positive beam signal B(ω) and a spectral negative beam signal Bn(ω). The spectral positive beam signal B(ω) is supplied to a speech blocking mask (ABM) block 703 which determines (calculates) a spectral speech blocking mask Mask(ω). The speech blocking mask Mask(ω) is multiplied with the spectral negative beam signal Bₙ(ω), e.g., by way of a multiplier 704 which outputs a spectral estimated noise signal E(ω). Optionally, the spectral positive beam signal B(ω) is delayed in time by a delay block 705 to output a delayed spectral positive beam signal B_{d}(ω) which is B(ω)·e^{-jωγ} with γ being the delay time and which is supplied together with the spectral estimated noise signal E(ω) to an adaptive interference canceler (AIC) block 706 such as AIC block 600 shown in FIG. 1. The AIC block 706 may include an adaptive post filter (APF) block (not shown) and outputs a spectral output signal N(ω).

Thus, one exemplary way to determine (calculate) the desired weighting, i.e., blocking mask(n) respectively spectral blocking mask Mask (ω), is to use the signal representative of the positive beam b(n) as a baseline signal, since this signal has the best SNR, which allows a more robust calculation of the blocking mask mask(n) which can then be applied to the signal representative of the negative beam bₙ(n), or more generally to a signal having the worst SNR, in order to block potentially remaining speech signal parts still contained in it. Alternatively, only the signal with the worst SNR can be used as baseline signal, e.g., the signal representative of the negative beam bₙ(n), which is input into the ABM block 703, in order to generate the desired speech blocking mask mask(n) respectively spectral blocking mask Mask (ω), as depicted in FIG. 8. Here, the spectral blocking mask Mask (ω) derived from the spectral negative beam signal Bₙ(ω) is supplied to the AIC block 706 as spectral estimated noise signal E(ω).

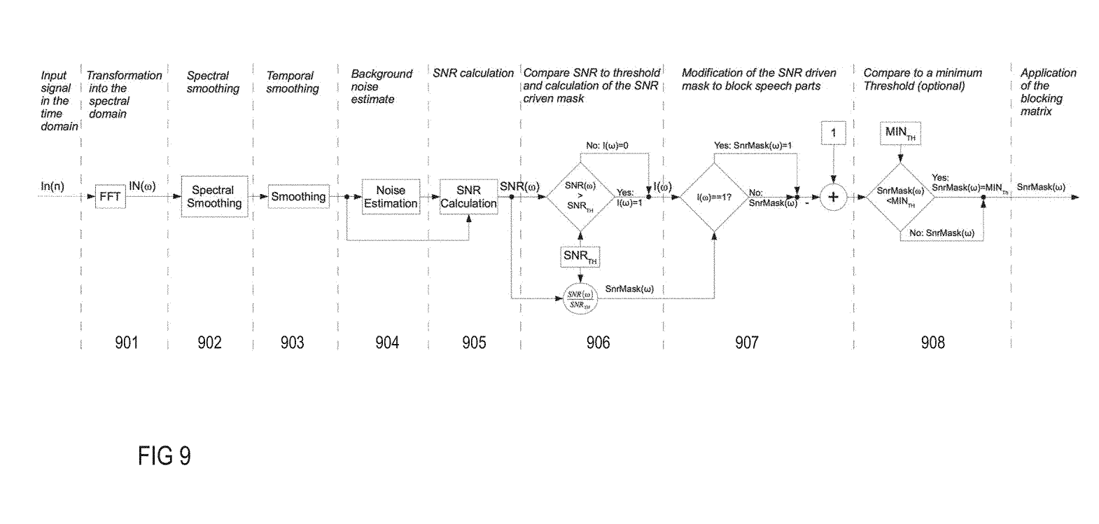

Referring to FIG. 9, an exemplary implementation of a time-varying speech blocking mask block which is applicable as speech blocking mask block 703 in the adaptive blocking filter blocks described above in connection with FIGS. 7 and 8 or in any other application, may include an optional domain transformation block 901, in which an input signal in(n) is transformed from the time domain into the spectral domain, i.e., into a spectral input signal IN(ω), e.g., by way of a fast Fourier transformation (FFT), unless a spectral input signal is already available such as signals B(ω) or Bₙ(ω) in the ABF blocks described above in connection with FIGS. 7 and 8. The input signal can be any signal as, for example, microphone signals and may include signals with the best or the worst SNR. The spectral input signal IN(ω), i.e., its spectrum, is supplied to an optional spectral smoothing block 902 for (temporal) smoothing of each spectral line (Bin) of the spectrum. Depending on whether the optional spectral smoothing block 902 is present or not, a subsequent temporal smoothing block 903 for temporal smoothing is connected to the optional spectral smoothing block 902 (as shown) or to the spectral transformation block 901 (not shown). Smoothing a signal may include filtering the signal to capture important patterns in the signal, while leaving out noisy, fine-scale and/or rapidly changing patterns.

A background noise estimation block 904 is connected to and downstream of the temporal smoothing block 903 and may utilize any known method that allows for determining or estimating the background noise contained in the input signal in(n). In the example shown, the signal to be evaluated, spectral input signal IN(ω), is in the spectral domain so that the background noise estimation block 904 is designed to operate in the spectral domain.

In a spectral signal-to-noise ratio determination (calculation) block 905 connected downstream of the background noise estimation block 904, the signals input into and the signals output by the background noise estimation block 904 are processed to provide a spectral signal-to-noise ratio SNR(ω). For example, the spectral signal-to-noise ratio determination block 905 may divide the signal input into the background noise estimation block 904 by the signal output by the background noise estimation block 904 to determine the spectral signal-to-noise ratio SNR(ω).

In a first evaluation block 906 connected to and downstream of the spectral signal-to-noise ratio determination block 905, the estimated signal-to-noise ratio SNR(ω) in the spectral domain is compared (e.g., within a predetermined frequency band) to a predetermined signal-to-noise ratio threshold SNR_{TH}. If the estimated signal-to-noise ratio SNR(ω) exceeds the signal-to-noise ratio threshold SNR_{TH}, a weighting mask I(ω) output by the first evaluation block 906 is set to a predetermined maximum signal-to-noise ratio value, e.g., an overestimation factor MaxSnrTh. Otherwise, the weighting mask I(ω) may be set to a constant value, e.g., one. The first evaluation block 906 further outputs a signal-to-noise ratio mask SnrMask(ω) which is derived from the estimated signal-to-noise ratio SNR(ω) by dividing the estimated signal-to-noise ratio SNR(ω) by the signal-to-noise ratio threshold SNR_{TH}.

In a noise blocking block 907, the SNR driven mask, the signal-to-noise ratio mask SnrMask(ω) from the first evaluation block 906, is modified to generate a once modified SNR mask SnrMask′(ω), e.g., by setting the signal-to-noise ratio mask SnrMask′(ω) from the first evaluation block 906 to one, if the weighting mask I(ω) is one, and to SnrMask(ω) otherwise. Then, the once modified signal-to-noise ratio mask SnrMask′(ω) is subtracted from one to generate a twice modified signal-to-noise ratio mask SnrMask″(ω).

In an optional second evaluation block 908 connected to and downstream of the noise blocking block 907, the twice modified SNR mask SnrMask″(ω) is compared to a minimum threshold MIN_{TH}. If the twice modified SNR mask SnrMask″(ω) undercuts the minimum threshold MIN_{TH}, a triply modified SNR mask SnrMask′″(ω) is set to the minimum threshold MIN_{TH}, otherwise the triply modified SNR mask SnrMask′″(ω) assumes the twice modified SNR mask SnrMask″(ω).

In the first blocks of the blocking mask block shown in FIG. 9, the time-varying SNR values in the frequency domain, i.e., values of the spectral SNR or noise spectrum, are estimated, and are then compared to the predetermined tunable SNR threshold SNR_{TH}. Dependent on the result of this comparison, the weighting mask I(ω) is generated whose values may be set to the neutral weight of one if the current spectral SNR(ω) does not exceed the given SNR threshold SNR_{TH}. Otherwise, the weighting mask I(ω) is set to one. The weighting mask I(ω) indicates bins that exceed the given threshold SNR_{TH} by a value of one, whereas all remaining spectral lines are indicated by zeros. In a side path, the currently estimated, spectral SNR values SNR(ω) may be scaled by the given SNR threshold SNR_{TH}, which delivers the desired mask SnrMask(ω)=SNR(ω)/SNR_{TH}. Successively, the mask will be modified dependent on the weights of weighting mask I(ω) to the once modified spectral SNR mask SnrMask′(ω) which assumes either one, if I(ω)=1, or SnrMask(ω) otherwise. The once modified spectral SNR mask SnrMask′(ω) is subtracted from one to form the twice modified spectral SNR mask SnrMask″(ω). At all spectral lines of the spectral SNR mask SnrMask(ω), at which the weighting mask I(ω) equals one, the once modified spectral SNR mask SnrMask′(ω) will also be set to one, before it will subtracted from the constant value of one, which effectively leads to an inversion of the spectral SNR mask SnrMask(ω). The resulting twice modified mask SnrMask″(ω) will then optionally be limited to a lower bound, given by the minimum threshold MIN_{TH}, before it actually acts as the desired speech blocking mask, which is the triple modified mask SnrMask′″(ω).

In other words, based on the current estimated spectral SNR signal SNR(ω), which is normalized to the given threshold SNR_{TH} and which eventually is inverted by subtracting it from one, a mask is generated which is able to suppress impulsive signals, such as speech. Thereby, parts of the SNR signal SNR(ω) exceeding the given threshold SNR_{TH}, indicate such impulsive signals, marked by ones of the signal I(ω), which is otherwise set to zero. By limiting the normalized SNR signal to a maximum of one before it is inverted by subtracting it from one, all signal parts indicated as impulsive will result in a speech blocking mask equal to zero and hence will completely be blocked. All remaining spectral parts will result in weights residing within a range of 1≤SnrMask (ω)≤0, depending on the momentary, normalized SNR signal SNR(ω)/SNR_{TH}. Optionally, the lower bound of the valid range may be adjusted by the minimum threshold MIN_{TH}, resulting in a new valid range of 1≤SnrMask (ω)≤MIN_{TH}.

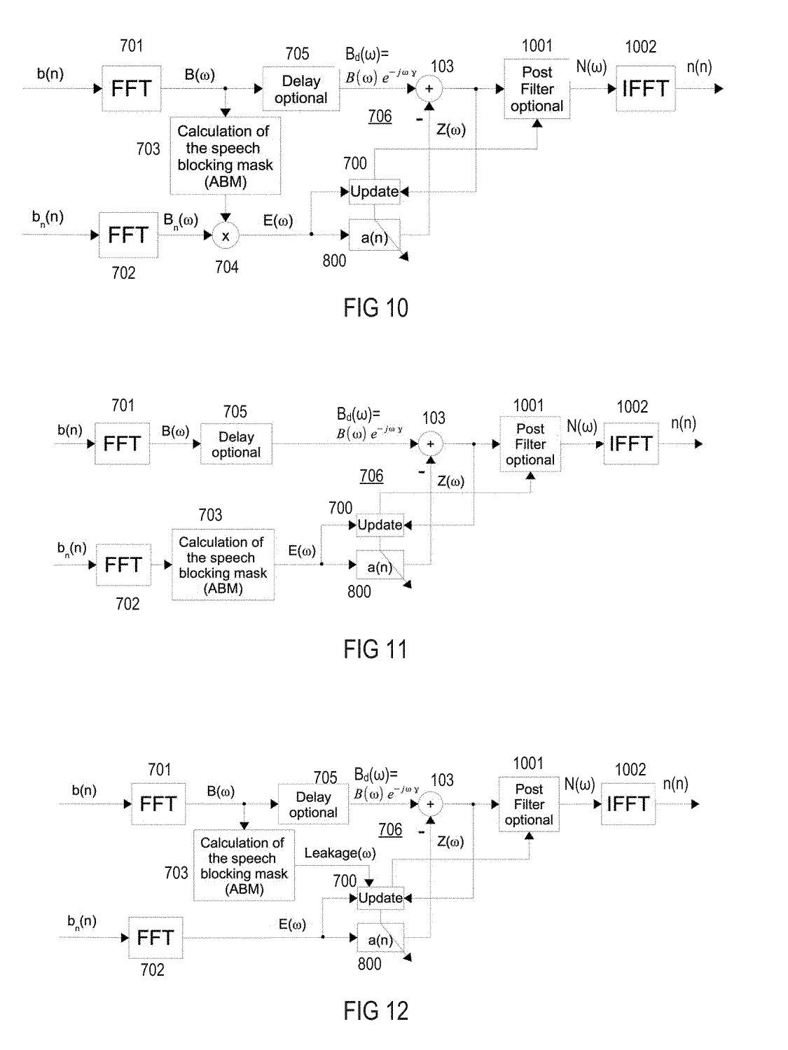

FIG. 10 illustrates a combination of the spectral ABM described in connection with FIG. 7 and a frequency domain (spectral) version of the AIC block described in connection with FIG. 5 with an additional spectral APF block 1001, e.g., corresponding to APF block 104 shown in FIG. 1, and an additional domain transformation block 1002, in which the output signal N(ω) is transformed from the frequency domain into the signal n(n) in the time domain. Accordingly, signal z(n) in FIG. 5 corresponds to a spectral signal Z(ω) in FIG. 10. Further, for the sake of simplicity, the reference numbers of the time domain version of the AIC block shown in FIG. 5 are also used in the frequency domain (spectral) version shown in FIGS. 10-12 for corresponding parts.

FIG. 11 illustrates a combination of the ABM described in connection with FIG. 8 and the frequency domain version of the AIC block described in connection with FIG. 5 with an additional spectral APF block 1001 and an additional domain transformation block 1002, in which the output signal N(ω) is transformed from the frequency domain into signal n(n) in the time domain. Again, signal z(n) in FIG. 5 corresponds to a spectral signal Z(ω) in FIG. 11. Here, the resulting weighting mask, blocking mask Mask(ω), is applied to itself, i.e. to the respective input signal such as the spectral negative beam signal Bₙ(ω), in order to block remaining speech signals still contained in the input signal to generate the reference signal, spectral estimated noise signal E(ω), w for the successive AIC block. The blocking mask Mask(ω) may be generated with a system and method described above in connection with FIG. 9.

It should be noted that in both cases described above, the reference signal for the AIC stage, i.e. the essentially speech-free noise signal, suffers under spectral subtraction, which means that E(ω) may contain so-called musical tones aka musical noise. But since there is no correlation between these musical tones and the desired signal of the AIC stage, represented by the, optionally time-delayed version of the positive beam signal B(ω)) e^{-jωγ}, this will not affect the output signal of the AIC stage before it is supplied to the subsequent adaptive post filter block. As a result, the above-described systems and methods provide noise reduction without otherwise unavoidable, acoustic artifacts, such as musical tones.

Another possibility for avoiding an unintentional suppression of desired signal parts, such as speech, within the AIC block, is to use the speech blocking mask from the ABM block as a spectral dependent, time-varying leakage signal Leakage(ω) input into the AIC block, e.g., its update part, i.e., filter control block 700, with the spectral estimated noise signal E(ω) being the spectral negative beam signal Bₙ(ω). FIG. 12 illustrates an exemplary implementation based on the system shown in FIG. 10, in which the signal with the best SNR, spectral positive beam signal B(ω), is used as input to the ABM stage, but also other signals may be used as well. This option can be described by the following equation:

$$W ( n + 1 , k ) = Leakage ( n , k ) \cdot W ( n + 1 , k ) + \frac{μ ( n , k )}{{p}_{x} ( n , k ) δ} \cdot {E ( n , k )}^{*} \cdot X ( n , k )$$

in which W(n, k) is a transfer function of the time and frequency dependent adaptive filter, Leakage (n, k) is the time and frequency dependent leakage, μ(n, k) is a time and frequency dependent adaptive step size, pₓ (n, k) is a time and frequency dependent energy of the input signal, δ is a small value to avoid divisions by zero, E(n, k) is a time and frequency dependent error signal, (·)* is a complex conjugate operation, X(n, k) is a time and frequency dependent input signal, n is a discrete time index, and k is a discrete frequency index (bin).

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices. The described methods and associated actions may also be performed in various orders in addition to the order described in this application, in parallel, and/or simultaneously. The described systems are exemplary in nature, and may include additional elements and/or omit elements.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects.

The embodiments of the present disclosure generally provide for a plurality of circuits, electrical devices, and/or at least one controller. All references to the circuits, the at least one controller, and other electrical devices and the functionality provided by each, are not intended to be limited to encompassing only what is illustrated and described herein. While particular labels may be assigned to the various circuit(s), controller(s) and other electrical devices disclosed, such labels are not intended to limit the scope of operation for the various circuit(s), controller(s) and other electrical devices. Such circuit(s), controller(s) and other electrical devices may be combined with each other and/or separated in any manner based on the particular type of electrical implementation that is desired.

A block is understood to be a hardware system or an element thereof with at least one of: a processing unit executing software and a dedicated circuit structure for implementing a respective desired signal transferring or processing function. Thus, parts or all of the system may be implemented as software and firmware executed by a processor or a programmable digital circuit. It is recognized that any system as disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any system as disclosed may utilize any one or more microprocessors to execute a computer-program that is embodied in a non-transitory computer readable medium that is programmed to perform any number of the functions as disclosed. Further, any controller as provided herein includes a housing and a various number of microprocessors, integrated circuits, and memory devices, (e.g., FLASH, random access memory (RAM), read only memory (ROM), electrically programmable read only memory (EPROM), and/or electrically erasable programmable read only memory (EEPROM).

While various embodiments of the invention have been described, it will be apparent to those of ordinary skilled in the art that many more embodiments and implementations are possible within the scope of the invention. In particular, the skilled person will recognize the interchangeability of various features from different embodiments. Although these techniques and systems have been disclosed in the context of certain embodiments and examples, it will be understood that these techniques and systems may be extended beyond the specifically disclosed embodiments to other embodiments and/or uses and obvious modifications thereof.

What is claimed is:

1. An adaptive blocking system, comprising a blocking mask block configured to generate from at least one of a desired signal and an undesired signal input into the blocking mask block an output signal that per se or in combination with the desired signal or undesired signal provides a mask signal, wherein the undesired signal includes components occurring also in the desired signal or the desired signal includes components occurring also in the undesired signal, and the output signal is the undesired signal with reduced or no components occurring also in the desired signal, or the desired signal with reduced or no components occurring also in the undesired signal.

2. The system of claim 1, wherein the blocking mask block is configured to receive the desired signal and to provide a mask signal that is the desired signal with reduced or no components occurring also in the undesired signal; and the system further comprises a combining block configured to combine the mask signal of the blocking mask block with the undesired signal to provide an output signal of the adaptive blocking system that is the undesired signal with reduced or no components occurring also in the desired signal.

3. The system of claim 2, wherein the combining block is configured to multiply in the frequency domain the output signal of the blocking mask block and the undesired signal.

4. The system of claim 2, wherein the combining block is an update control block of an adaptive interference controller.

5. The system of claim 1, wherein the blocking mask block is configured to receive the undesired signal and to provide a mask signal that is the undesired signal with reduced or no components occurring also in the desired signal, the mask signal forming the output signal of the adaptive blocking system which is the undesired signal with reduced or no components occurring also in the desired signal.

6. The system of claim 1, wherein the blocking mask block comprises:
a detector block configured to detect in an input signal which is the desired signal or undesired signal, undesired signal components in the desired signal or desired signal components in the undesired signal based on a signal-to-noise ratio spectrum of the input signal; and
a masking block configured to generate a final blocking mask that is configured to suppress the desired components in the undesired signal or undesired components in the desired signal.

7. The system of claim 6, wherein the detector block comprises a signal-to-noise ratio determination block that is configured to determine the signal-to-noise ratio spectrum of the input signal by determining signal-to-noise ratios per discrete frequency of the input signal.

8. The system of claim 6, wherein the masking block comprises:
a first evaluation block configured to generate from the signal-to-noise ratio spectrum of the input signal a basic spectral mask, the first evaluation block further configured to compare the signal-to-noise ratio spectrum of the input signal to a predetermined signal-to-noise ratio threshold and to provide a weighting mask dependent on the results of the comparison; and
a mask modification block configured to modify the basic blocking mask dependent on the weighting mask to provide a once-modified spectral blocking mask.

9. The system of claim 8, wherein the masking block further comprises a second evaluation block that is configured to compare the once-modified spectral blocking mask to a minimum threshold and to provide a twice-modified spectral blocking dependent on the results of the comparison.

10. An adaptive blocking method, comprising: generating from at least one of a desired signal and an undesired signal input into a blocking mask an output signal that per se or in combination with the desired signal or undesired signal provides a mask signal, wherein the undesired signal includes components occurring also in the desired signal or the desired signal includes components occurring also in the undesired signal, and the output signal is the undesired signal with reduced or no components occurring also in the desired signal, or the desired signal with reduced or no components occurring also in the undesired signal.

11. The method of claim 10, wherein the blocking mask is configured to receive the desired signal and to provide a mask signal that is the desired signal with reduced or no components occurring also in the undesired signal; and the method further comprises combining the mask signal of the spectral blocking mask block with the undesired signal to provide an output signal of the adaptive blocking method that is the undesired signal with reduced or no components occurring also in the desired signal.

12. The method of claim 11, wherein combining comprises multiplying in the frequency domain the output signal of the blocking mask block and the undesired signal.

13. The method of claim 11, wherein the step of combining is performed with an update control of an adaptive interference controller.

14. The method of claim 10, wherein the blocking mask is configured to receive the undesired signal and to provide a mask signal that is the undesired signal with reduced or no components occurring also in the desired signal, the mask signal forming the output signal of the adaptive blocking method which is the undesired signal with reduced or no components occurring also in the desired signal.

15. The method of claim 10, wherein the blocking mask comprises:
detecting in an input signal which is the desired signal or undesired signal, undesired signal components in the desired signal or desired signal components in the undesired signal based on a signal-to-noise ratio spectrum of the input signal; and
generating a final blocking mask that is configured to suppress the desired components in the undesired signal or the undesired components in the desired signal.

16. The method of claim 15, wherein detecting in an input signal which is the desired signal or undesired signal, undesired signal components in the desired signal or desired signal components in the undesired signal based on a signal-to-noise ratio spectrum of the input signal, comprises determining the signal-to-noise ratio spectrum of the input signal by determining signal-to-noise ratios per discrete frequency of the input signal.

17. The method of claim 15, wherein generating the final blocking mask comprises:
generating from the signal-to-noise ratio spectrum of the input signal a basic blocking mask;
comparing the signal-to-noise ratio spectrum of the input signal to a predetermined signal-to-noise ratio threshold;
providing a weighting mask dependent on the results of the comparison; and
modifying the basic spectral blocking mask dependent on the weighting mask to provide a once-modified spectral noise removal mask.

18. The method of claim 17, wherein generating the final spectral blocking mask comprises comparing the once-modified spectral blocking mask to a minimum threshold, and providing a twice-modified spectral blocking mask dependent on the results of the comparison.
